(19) United States
(12) Patent Application Publication
(10) Pub. No.: US 2005/0152381 A1
(43) Pub. Date: Jul. 14, 2005

(54) Network connecting system and method for data transmission in wireless personal area network

(75) Inventor: Won-soo Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/030,127

(22) Filed: Jan. 7, 2005

(30) Foreign Application Priority Data
Jan. 14, 2004 (KR) 2004-2702

(51) Int. Cl. H04L 12/28

(52) U.S. Cl. 370/401; 370/395.2

(57) ABSTRACT

In a communication system having at least two piconets, each having at least one device communicating using a single radio resource and a piconet coordinator controlling the device, a connecting method for communications amongst the device and the piconet coordinators of the other piconets. A router device, which is located in an overlapping area of at least two piconets and is connected with the piconet coordinators, requests connection to the piconet coordinator connected with the adjacent piconet coordinators of the overlapping piconets. Upon receiving the message of the connection permit from a piconet coordinator, the router device requests connection to the adjacent piconet coordinator. Upon receiving the message of the connection permit, the device connects with the adjacent piconet coordinator.

### CROSS-REFERENCE TO RELATED APPLICATIONS

This application claims the benefit of Korean Patent Application No. 2004-2702 filed on Jan. 14, 2004 in the Korean Intellectual Property Office, the disclosure of which is incorporated herein by reference in its entirety.

### BACKGROUND OF THE INVENTION

1. Field of The Invention

The present invention generally relates to a method for connecting (linking) at least two networks. More concretely, the present invention pertains to a method for connecting a plurality of networks forming a wireless personal area network (WPAN).

2. Description of The Related Art

A wireless personal area network (WPAN) wirelessly interconnects devices, such as computers and peripherals, mobile phones, and home appliances, in a short range of 10 m, supporting communications among the devices and thus providing various services. The WPAN has been developed to implement networks among the devices with the development of personal mobile digital devices such as laptop computers and personal digital assistants (PDAs). The WPAN has distinctive features including short range, compactness, low-power, usability (that is, when a user approaches to the WPAN, synchronization is automatically performed), and less interference.

FIG. 1 illustrates configuration of the WPAN (piconet). Referring to FIG. 1, the WPAN includes a piconet coordinator (PNC) and at least one device (DEV). The PNC is selected among the DEVs forming the WPAN. A network including the PNC 100 and the DEVs 110 through 114 in the WPAN refers to a piconet. The piconet covers a range where the DEVs are located or a range of about 10 m in which the DEVs can move. When a particular DEV needs to communicate data with another DEV in the piconet, the particular DEV requests that the PNC 100 allocate of radio resources for the data communication. The PNC 100 allocates the radio resources to the requested DEV. The PNC 100 allocates one radio resource at a specific time interval.

FIG. 2 illustrates another configuration of the piconet. Referring to FIG. 2, one piconet overlaps with the other piconet in the WPAN to extend the range of the data communication. In general, each piconet 220 and 222 communicates data using dedicated radio resources. Specifically, PNCs 200 and 202 select one available channel among 16 channels. DEVs and PNCs of the piconet 220 or 222 communicate with each other using the selected channel. Since the piconets 220 and 222 communicate using the dedicated radio resources, the piconets 220 and 222 do not have information on radio resources of the adjacent piconet. Consequently, the communication between the piconets of the WPAN is infeasible.

### SUMMARY OF THE INVENTION

To address the above problems and disadvantages of the conventional arrangement, an exemplary aspect of the present invention is to provide a system and method for connecting piconets forming a wireless personal area network (WPAN) for communications.

Another exemplary aspect of the present invention is to provide a system and method enabling other devices to perform some functions of a router device when the router device consumes considerable power.

Still another exemplary aspect of the present invention is to provide a system and method capable of varying a data reception period depending on the amount of data received from a piconet coordinator to the router device.

In view of the above exemplary aspects and features of the present invention, there is provided an exemplary embodiment of a method for a router device to connect the piconet coordinators in a communication system comprising at least two piconets each comprising at least one device communicating using a single radio resource and a piconet coordinator controlling the device. The method comprises the steps of requesting connection with a second piconet coordinator of an overlapping piconet by a first router device which is located in the overlapping area of the at least two piconets and is connected with a first piconet coordinator of the at least two piconets, requesting connection to the first piconet coordinator when a message indicating connection permit is received, and connecting with the second piconet coordinator when a message indicating connection permit is received.

Consistent with the another aspect of the present invention, in a communication system comprising at least two piconets each comprising at least one device communicating using a single radio resource and a piconet coordinator controlling the device, a system in which the device connects the piconet coordinators comprises a first router device connected with a first piconet coordinator, located in an overlapping area of the at least two piconets, sequentially requesting connection to a second piconet coordinator and the first piconet coordinator, and connecting with the second piconet coordinator when a message indicating a connection permit is received, the first piconet coordinator transmitting a message indicating the connection permit in response to the request from the router device, and the second piconet coordinator transmitting a message indicating the connection permit in response to the connection request from the router device and connecting with the device.

### BRIEF DESCRIPTION OF THE FIGURES

These and/or other aspects and advantages of the invention will become apparent and more readily appreciated from the following description of exemplary embodiments, taken in conjunction with the accompanying figures in which:

FIG. 1 illustrates a configuration of a WPAN;

FIG. 2 illustrates overlapping piconets in the WPAN;

FIG. 3 illustrates connections between a DEV located in an overlapping area of two piconets and PNCs;

FIG. 4 illustrates a message sequence chart for the connections of the DEV located in the overlapping area of FIG. 3;

FIG. 5 illustrates connections between a DEV located in an overlapping area of three piconets and PNCs according to another exemplary embodiment of the present invention;

FIG. 6 illustrates a message sequence chart for the connections of the DEV located in the overlapping area of FIG. 5;

FIG. 7 illustrates the consequent connection of FIG. 6;

FIG. 8 illustrates a reception period of beacons transmitted to PNCs from the DEV according to an exemplary embodiment of the present invention; and

FIG. 9 illustrates a reception period of beacons transmitted to PNCs from the DEV according to an exemplary embodiment of the present invention.

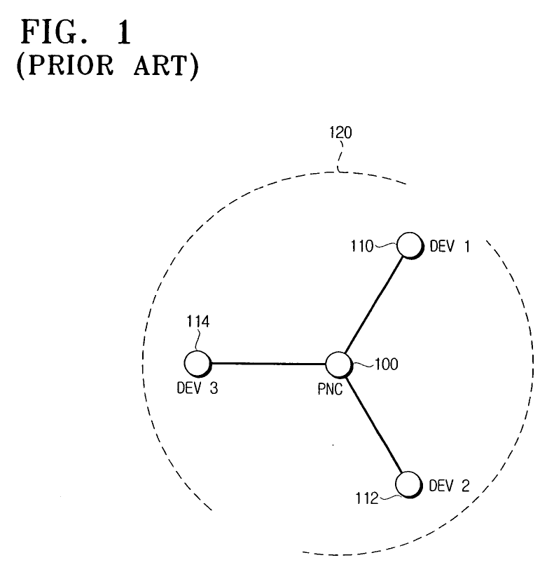

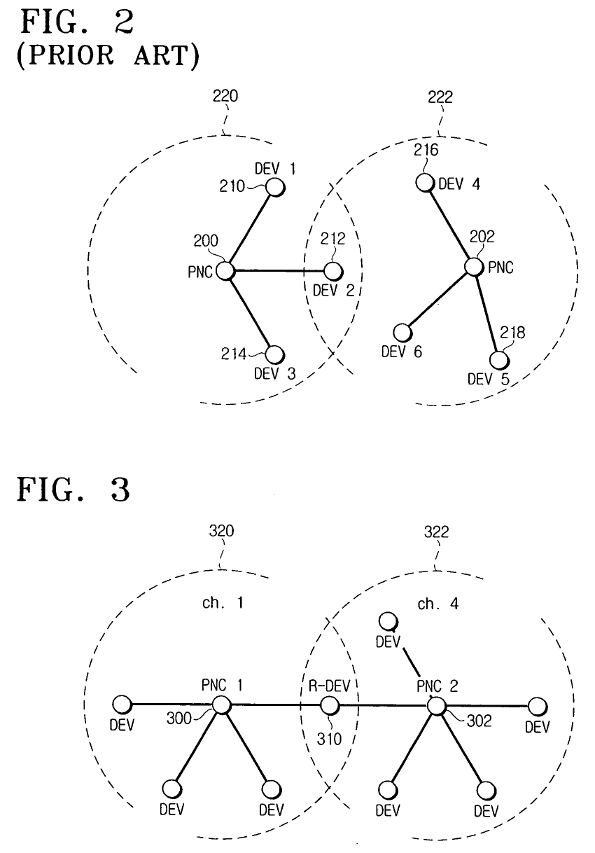

### DETAILED DESCRIPTION OF EXEMPLARY EMBODIMENTS

Reference will now be made in detail to exemplary embodiments of the present invention, examples of which are illustrated in the accompanying figures, wherein like reference numerals refer to the like elements throughout. The exemplary embodiments are described below in order to explain the present invention by referring to the figures.

FIG. 3 illustrates connections of piconets forming a wireless personal area network (WPAN), devices (DEVs), and a piconet coordinator (PNC) in each piconet according to an exemplary embodiment of the present invention. Hereinafter, a communication system including at least two piconets refers to an extended piconet.

An extended piconet of FIG. 3 includes a first piconet 320 controlled by a first PNC 300 and a second piconet 322 controlled by a second PNC 302. The first PNC 300 communicates with DEVs in the first piconet 320 using dedicated radio resources. The DEVs allocated with radio resources from the first PNC 300 communicate with each other. The second PNC 302 also communicates with DEVs in the second piconet 322 using dedicated radio resources. It is assumed that the dedicated radio resource for the first piconet 320 is channel 1 and that the dedicated radio resource for the second piconet 322 is channel 4.

A particular DEV of the extended piconet may be located in area where at least two piconets overlap, as shown in FIG. 3. That is, the DEV 310 is located in the overlapping area of the first and second piconets 320 and 322. Hereinafter, an overlapping area of at least two piconets refers to a router area, and a DEV in the router area refers to a router device (R-DEV). If a particular DEV is located in or moves into the router area, the particular DEV serves as the R-DEV. The following descriptions are made on a case when the DEV 310 moves into the router area and serves as the R-DEV.

The R-DEV 310 searches available radio resources in the router area and discovers the channel 1 for the first piconet 320 and the channel 4 for the second piconet 322. The R-DEV 310 is able to obtain the number of communicable piconets and PNCs by searching the available radio resources. The R-DEV 310 selects an initial piconet for data communication using the searched radio resources. It is assumed that the R-DEV 310 initially communicates data with the second PNC 302.

The R-DEV 310 sends a router function request message to the second PNC 302. The following Table 1 shows an example of the router function request message.

TABLE 1

| 2 | 1 | 1 | 3 × Connection list size |
|---|---|---|---|
| Header | Command | Connection list | Coordinator information |
| field | frame identifier | size | for connection |

| | |
|---|---|
| Header | Payload |

In Table 1, the number denotes a byte, and the command frame identifier indicates the router function request message. The connection list size represents the number of radio resources searched in the router area. The connection list size excludes the radio resources used in the piconet which the R-DEV is to initially communicate with. Hence, the connection list size of the R-DEV 310 of FIG. 3 becomes ‘1’ by excluding the channel 4 of the second piconet 322 from the searched two radio resources. The coordinator information for connection represents information on the second PNC 302 of the second piconet 322 when the R-DEV 310 is to connect with the second piconet 322. An example of the coordinator information for connection is shown in the following Table 2.

TABLE 2

| | |
|---|---|
| 2 | 1 |

| | | |
|---|---|---|
| Coordinator ID | Channel number | Reserved |

In Table 2, the coordinator ID represents an identifier of the PNC to be connected. The channel number represents a radio channel number used by the PNC. Referring back to FIG. 3, the coordinator ID is ‘1’ and the channel number is ‘1’. Table 2 is organized in correspondence with the piconet to be connected with the R-DEV.

Upon receiving the router function request message, the second PNC 302 sends a router function response message to the R-DEV 310. The following Table 3 shows an example of the router function response message.

TABLE 3

| 2 | 1 | 1 | 3 × Connection list size |
|---|---|---|---|
| Header | Command frame | Result | Coordinator information |
| field | identifier | size | For result |

| | |
|---|---|
| Header | Payload |

Table 3, the result size is the same as the connection list size, that is, it represents the number of piconets to be connected, which is contained in the router function request message. The coordination information for result represents results with respect to each piconet to be connected. The following Table 4 shows an example of the coordinator information for result.

TABLE 4

| | |
|---|---|
| 2 | 1 |

| | | |
|---|---|---|
| Coordinator ID | Channel number | Status |

In Table 4, the status represents connection status of the piconet to be connected. The following Table 5 shows an example of the status.

TABLE 5

| Status | Meaning |
|---|---|
| 000 | Connection permit |
| 001 | Connection reject |
| 010 | Connection hold |
| 111 | Reserved |

In Table 5, the connection permit denotes that the second PNC 302 permits connection of the R-DEV 310. The connection reject denotes that the second PNC 302 rejects connection of the R-DEV 310 (the R-DEV 310 does not need to perform the same function if an existing device links the first PNC 300 and the second PNC 302). The connection hold denotes that the R-DEV 310 does not need current connection with the first PNC 300 and the second PNC 302 but may need the connection afterward.

In order to create the router function response message, the second PNC 302 has to pre-store information on the existing DEV performing the router function. The second PNC 302 determines whether to permit or to reject the connection with respect to the DEV requesting the router function based on the pre-stored information. The following Table 6 shows an example of a information (connection information) table stored in the second PNC 302.

TABLE 6

| Coordinator ID | Channel | Router ID |
|---|---|---|
| ox0003 | channel 5 | ox0003 |
| ox0007 | channel 14 | ox0007 |
| . | . | . |
| . | . | . |
| . | . | . |

In Table 6, the second PNC 302 is connected with a third PNC using channel 5 via a R-DEV 3 and with a seventh PNC using channel 14 via a R-DEV 7. The second PNC 302 permits connection function of the R-DEV 310 based on Table 6. When delivering information on the connection permit, the connection information table is updated so as to contain information on the permitted R-DEV. When delivering information on the connection hold to the R-DEV, the second PNC 2 stores information on the R-DEV. The information may be stored in the same storage as with Table 6 or in a separate storage. A certain identifier is attached to the information for the separate storage. Hence, the second PNC 302 is able to allow the R-DEV to serve as the router.

The following Table 7 shows an example of the router function request message sent from the second PNC 302 to the R-DEV 310. As shown in FIG. 3, the PNC can send the router function request message to the R-DEV.

TABLE 7

| 2 | 1 | 1 | 2 × Router list size |
|---|---|---|---|
| Header | Command frame | Router list | Router ID |
| field | identifier | size | |

| | |
|---|---|
| Header | Payload |

The router list size represents the number of the R-DEV requesting the router function, and the router ID represents an identifier of the R-DEV requesting the router function.

Upon receiving the connection reject or connection hold message, the R-DEV 310 aborts the connection attempt with respect to the first PNC 300 and attempts to communicate with the second PNC 302 or the DEVs in the second piconet 322. The following descriptions are made with respect to when the R-DEV 310 receives the connection permit message or the router function request message. The R-DEV 310 sends a router function allowance request message to the first PNC 300. The R-DEV 310 changes to the radio channel used in the first piconet 320 so as to send the router function allowance request message to the first PNC 300. Upon receiving the router function allowance request message, the first PNC 300 sends a router function allowance response message.

The first PNC 300, which also stores information as shown in Table 6, determines the response for the router function allowance request message based on Table 6. If the connection function for the R-DEV 310 is allowed, the first PNC 300 sends the router function allowance response message indicating the allowance. If the connection function is not allowed, the first PNC 300 sends the router function allowance message indicating the disapproval. For the transmission of the router function allowance response message indicating the allowance, the first PNC 300 updates the Table 6. Specifically, the first PNC 300 adds information to the Table 6 that the second PNC 302 using the channel 4 is being connected via the R-DEV 310.

Upon receiving the router function allowance response message, the R-DEV 310 changes to the radio channel used in the second piconet 322. A connection message is sent to the second PNC 302 through the changed radio channel. Upon receiving the connection message, the second PNC 302 deletes the information on the R-DEV 310 from the connection information table when the connection message contains information indicating the disapproval of the connection function.

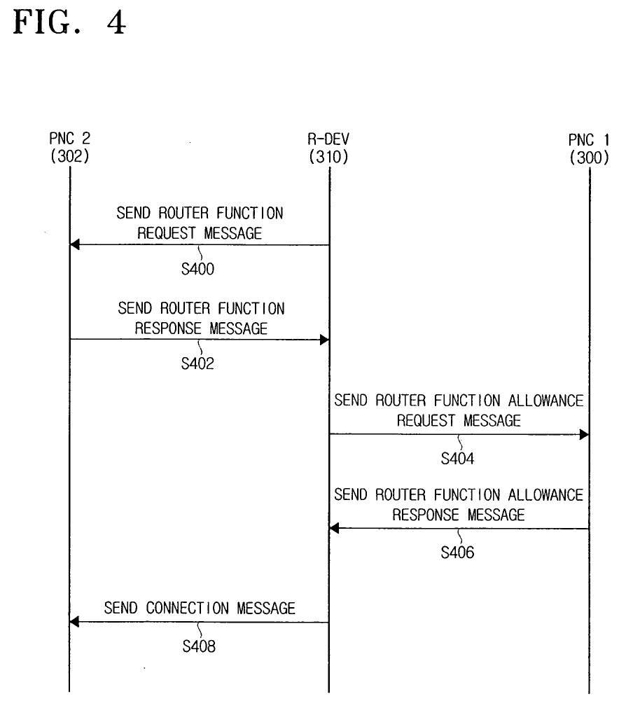

FIG. 4 illustrates a sequence of the message transmitted among the first PNC 300, the second PNC 302, and the R-DEV 310, which is described below.

The R-DEV 310 sends the router function request message to the second PNC 302 at step S400. Upon receiving the router function request message, the second PNC 302 sends the router function response message to the R-DEV 310 at step S402. The information contained in the router function response message is generated as aforementioned with reference to FIG. 3.

The R-DEV 310 sends the router function allowance request message to the first PNC 300 at step S404. Upon receiving the router function allowance request message, the first PNC 300 sends the router function allowance response message to the R-DEV 310 at step S406. The information contained in the router function allowance response message is generated as aforementioned with reference to FIG. 3. Upon receiving the router function allowance response message, the R-DEV 310 sends the connection message to the second PNC 302 at step S408.

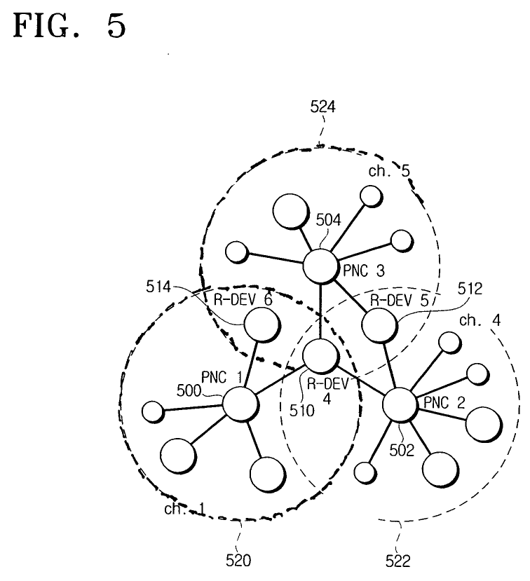

FIG. 5 illustrates three piconets according to another exemplary embodiment of the present invention. Referring to FIG. 5, a first PNC 500 manages the first piconet 520, a second PNC 502 manages the second piconet 522, and a third PNC 504 manages the third piconet 524. The first piconet 520 uses channel 1, the second piconet 522 uses channel 4, and the third piconet 524 uses channel 5 for communication. A fourth R-DEV 510 serves to interconnect the first through third PNCs 500, 502, and 504. The following Table 8 shows an example of the information (connection information) table stored in the second PNC 502.

TABLE 8

| Coordinator ID | Channel | Router ID |
|---|---|---|
| ox0001 | channel 1 | ox0004 |
| ox0003 | channel 5 | ox0004 |
| . | . | . |
| . | . | . |
| . | . | . |

Still referring to FIG. 5, a fifth R-DEV 512 moves into the router area between the second piconet 522 and the third piconet 524. The fifth R-DEV 512 performs the same functions as the R-DEV 310 of FIG. 3. The fifth R-DEV 512 sends a router function request message to the second PNC 502. Upon receiving the router function request message, the second PNC 502 sends a router function response message to the fifth R-DEV 512. It is assumed that the router function response message indicates the connection permit. After sending such a router function response message, the second PNC 502 updates the connection information table, which is shown by way of example in the following Table 9.

TABLE 9

| Coordinator ID | Channel | Router ID |
|---|---|---|
| ox0001 | channel 1 | ox0004 |
| ox0003 | channel 5 | ox0004 |
| ox0003 | channel 5 | ox0005 |

The fifth R-DEV 512 sends a router function allowance request message to the third PNC 504. Upon receiving the router function allowance request message, the third PNC 504 sends a router function allowance response message to the fifth R-DEV 512. If the router function allowance response message indicates the connection permit, the second PNC 502 maintains the information as shown in Table 9.

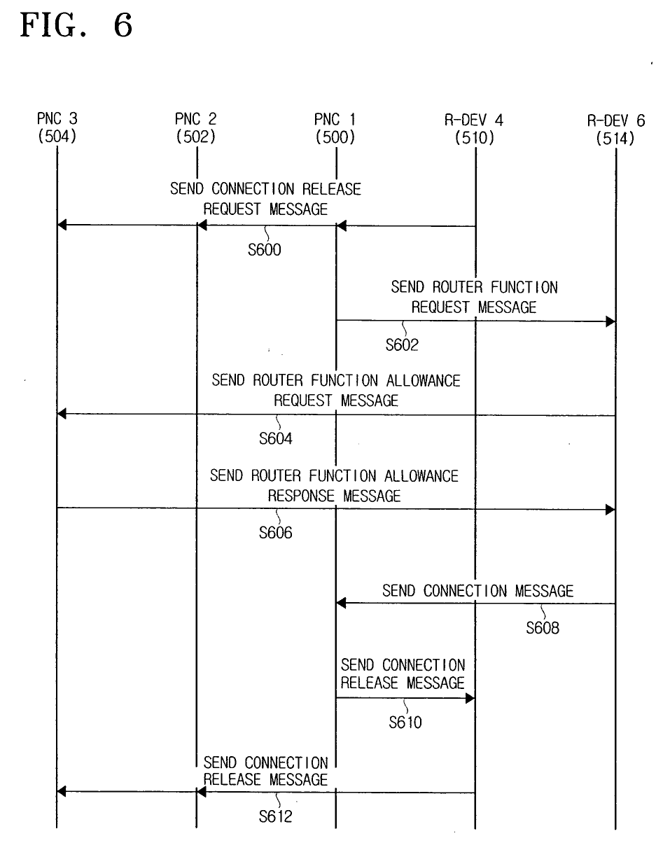

Referring to FIG. 5, the fourth R-DEV 510 consumes more power than the other DEVs. Hence, it is necessary that the other DEVs perform some functions of the fourth R-DEV 510. FIG. 6 illustrates the other DEVs performing some functions of the fourth R-DEV 510 that consumes considerable power, which is described below in detail.

Referring to FIGS. 5 and 6, the fourth R-DEV 510 sends a connection release request message to the first through third PNCs 500, 502, and 504 at step S600. Upon receiving the connection release request message, the first through third PNCs 500, 502, and 504 look up the stored connection information table to obtain information on a R-DEV of which connection is held. The first PNC 500 obtains, from Table 5, information on the sixth R-DEV 514 of which connection is held.

The first PNC 500 sends a router function request message to the sixth R-DEV 514 at step S602. Upon receiving the router function request message, the sixth R-DEV 514 retrieves information on a connectable piconet. As a result of the retrieval, the sixth R-DEV 514 obtains information on the third PNC 504. The sixth R-DEV 514 sends a router function allowance request message to the third PNC 504 based on the obtained information at step S604. Upon receiving the router function allowance request message, the third PNC 504 sends a router function allowance response message to the sixth R-DEV 514 at step S606.

The sixth R-DEV 514 sends a connection message to the first PNC 500 at step S608. It is assumed that the connection message contains information on the connection permit. Upon receiving the connection message, the first PNC 500 sends a connection release message to the fourth R-DEV 510 at step S610. Then, the first PNC 500 deletes, from the connection information table, the information instructing that the fourth R-DEV 510 is connected with the third PNC 504 using the channel 5. The fourth R-DEV 510 sends the received connection release message to the second and third PNCs 502 and 504 at step S612. Upon receiving the connection release message, the second and third PNCs 502 and 504 delete the information indicating that the fourth R-DEV 510 is connected with the third PNC 504 using the channel 5. The following Table 10 shows an example of the connection information table of which some information is deleted by the second PNC 502.

TABLE 10

| Coordinator ID | Channel | Router ID |
|---|---|---|
| Ox0001 | channel 1 | ox0004 |
| ox0003 | channel 5 | ox0005 |

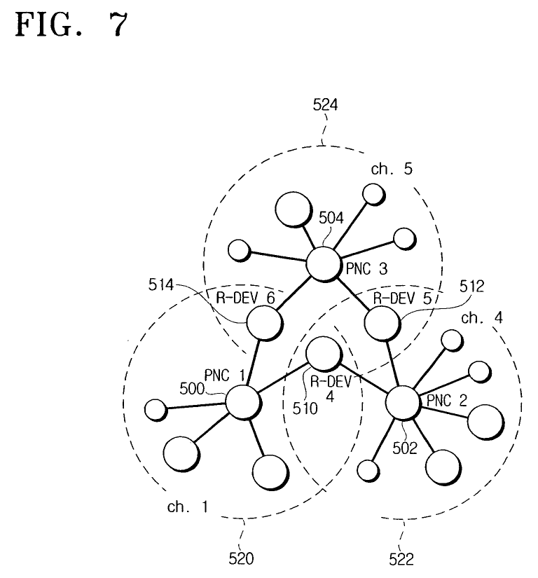

FIG. 7 illustrates connections of the R-DEVs after transmitting the messages of FIG. 6. Referring to FIG. 7, the fourth R-DEV 510 is disconnected with the third PNC 504. Instead, the sixth R-DEV 514 is connected with the third PNC 504. The fourth R-DEV 510 interconnects the first PNC 500 and the second PNC 502. The fifth R-DEV 512 interconnects the second PNC 502 and the third PNC 504. The sixth R-DEV 514 interconnects the third PNC 504 and the first PNC 500. Such connections allow the fourth R-DEV 510 through the sixth R-DEV 514 to consume substantially the same power for the communication.

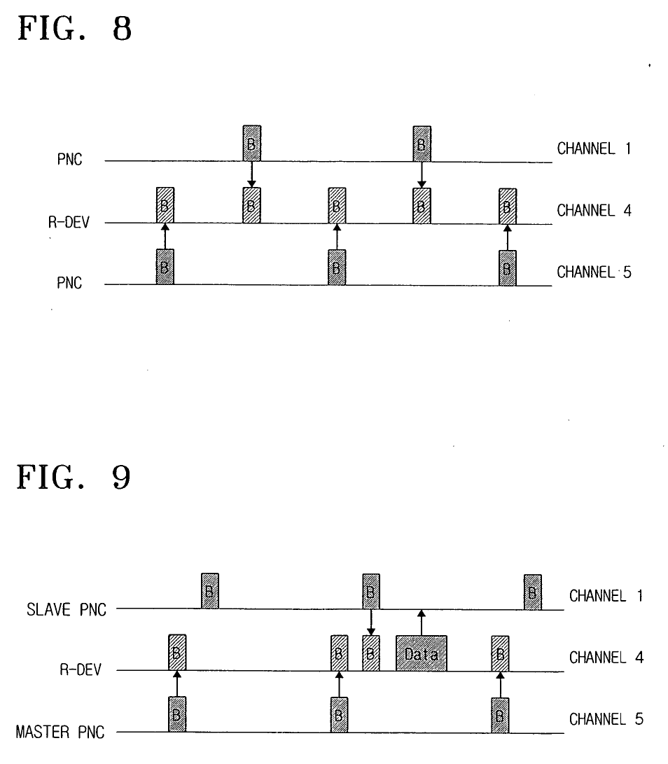

FIG. 8 illustrates synchronization for data transmission among two PNCs and a R-DEV connected with the two PNCs according to an exemplary embodiment of the present invention. Referring to FIG. 8, the R-DEV has to receive a frame carrying sync information from each PNC to acquire synchronization. The PNCs append the sync information to a beacon period of the frame and transmit the frame. The beacon period also contains information on data amount (size) to be transmitted to the R-DEV from the PNCs. The R-DEV, which is connected with the at least two PNCs, needs to change to a channel corresponding to each PNC to acquire synchronization. The more frequently the channel changes, the more power the R-DEV consumes. According to an embodiment of the present invention, channel change period varies depending on a piconet device.

Still referring to FIG. 8, the PNCs are divided into a master PNC and a slave PNC. The master PNC receives a router function request message from the R-DEV, and the slave PNC receives a router function allowance request message from the R-DEV. The R-DEV receives by one frame a beacon transmitted from the master PNC. Meanwhile, the R-DEV receives by two frames a beacon transmitted from the slave mater PNC.

FIG. 9 illustrates a beacon reception period that varies depending on the type of the PNC. The R-DEV receives, per frame, the beacons from the master PNC, and receives every two frames, the beacons from the slave PNC. The R-DEV obtains information on data to be received from the PNCs by use of the beacons. The R-DEV sends to the slave PNC the data received from the master PNC as shown in FIG. 9. Since the R-DEV does not receive the beacons transmitted from the slave PNC every frame, the power consumption is reduced.

Disadvantageously, the R-DEV may receive more data from the slave PNC than from the master PNC. To prevent such a disadvantage, the slave PNC occasionally checks the data amount to be transmitted to the R-DEV. If the data amount to be transmitted exceeds a predetermined amount, exchange of the master PNC and the slave PNC is requested of the R-DEV. Information on the exchange request is conveyed using a certain period of the beacon. Upon receiving the information, the R-DEV exchanges the master and slave PNCs. The beacon reception period of the master PNC is a frame in this embodiment but a user may vary the beacon reception period variously. It should be appreciated that the beacon reception period of the master PNC is shorter than that of the slave PNC.

In light of the foregoing, in the WPAN including at least two piconets, the DEVs in different piconets are interconnected so that communications are feasible between the piconets. Since some functions of the DEV serving to interconnect the piconets are performed by the other DEVs, power consumption reduces remarkably.

While the embodiments of the present invention have been described, additional variations and modifications of the embodiments may occur to those skilled in the art once they learn of the basic inventive concepts. Therefore, it is intended that the appended claims shall be construed to include both the above embodiments and all such variations and modifications that fall within the spirit and scope of the invention.

1. In a communication system comprising at least two piconets, each comprising at least one device communicating using a single radio resource and a piconet coordinator controlling the device, a method for a router device to connect the piconet coordinators comprising:
requesting connection with a second piconet coordinator of an overlapping piconet by a first router device which is located in the overlapping area of the at least two piconets and is connected with a first piconet coordinator of one of the at least two piconets;
requesting connection to the first piconet coordinator when a message indicating connection permit is received; and
connecting with the second piconet coordinator when a message indicating connection permit is received.

2. The method of claim 1, wherein each piconet coordinator is connected with the first router device using a dedicated radio resource.

3. The method of claim 1, wherein the second piconet coordinator receiving the connection request permits connection with the first router device when the first piconet coordinator is not connected.

4. The method of claim 3, wherein the second piconet coordinator permitting the connection stores an identifier of the first piconet coordinator and information on radio resources.

5. The method of claim 1, wherein the second piconet coordinator stores information on a second router device connected with the first piconet coordinator when the first piconet coordinator is previously connected.

6. The method of claim 5, wherein the first router device requests connection release from each piconet coordinator when at least three piconet coordinators are connected.

7. The method of claim 6, wherein at least one of said each piconet coordinator receiving the connection release request determines storage of information on at least one router device of which connection was not previously permitted among router devices that have requested connection to the piconet coordinator receiving the connection release request.

8. The method of claim 6, wherein at least one router device requests connection with said at least one of said each piconet coordinator that did not previously permit another device to connect.

9. The method of claim 8, wherein at least one connected router device instructs release of an existing connection when said at least one connected router device establishes connection with a piconet coordinator to which connection was not previously permitted.

10. The method of claim 1, wherein the first router device connected with at least two piconet coordinators varies a connection period depending on an amount of data received from the at least two piconet coordinators.

11. The method of claim 10, wherein the connection period of one of said at least two piconet coordinators having a larger amount of data to be transmitted, becomes shorter.

12. The method of claim 11, wherein the connection period is re-set to be shorter when an amount of data stored in a transmission buffer of said one of the at least two piconet coordinators exceeds a predetermined amount.

13. In a communication system comprising at least two piconets, each comprising at least one device communicating using a single radio resource and a piconet coordinator controlling the at least one device, said communication system, in which a router connects the piconet coordinators, comprising:
a first router device connected with a first piconet coordinator, located in an overlapping area of the at least two piconets, sequentially requesting connection to a second piconet coordinator and the first coordinator, to establish connection between the first piconet coordinator and the second piconet coordinator, and connecting with the second piconet coordinator when a message indicating a connection permit is received;
the first piconet coordinator transmitting a message indicating the connection permit in response to the request from the first router device; and
the second piconet coordinator transmitting a message indicating the connection permit in response to the connection request from the first router device and connecting with the first router device.

14. The system of claim 13, wherein the first and second piconet coordinators are connected with the first router device using dedicated radio resources.

15. The system of claim 13, wherein the first piconet coordinator permits the connection with the first router device when the second piconet coordinator is not connected.

16. The system of claim 15, wherein the first piconet coordinator stores an identifier of the second piconet coordinator requesting the connection and information on radio resources.

17. The system of claim 13, wherein the first piconet coordinator stores information on a connected second router device when the second piconet coordinator is previously connected to the second router device.

18. The system of claim 17, wherein the first router device requests connection release from each piconet coordinator when at least three piconet coordinators are connected.

19. The system of claim 18, wherein piconet coordinator receiving the connection release request determines storage of information on a device of which connection is not permitted among the devices requesting connection.

20. The system of claim 19, wherein the piconet coordinator instructs adjacent piconet coordinators to request connection with the device of which connection is not permitted.

21. The system of claim 20, wherein the device receiving a message indicating the connection permit instructs release of an existing connection.

22. The system of claim 13, wherein the first router device varies a connection period depending on an amount of data received from the piconet coordinators when data is received from at least two piconet coordinators.

23. The system of claim 22, wherein the first router device shortens the connection period with respect to one of the at least two piconet coordinators having a large amount of the data to be received.

24. The system of claim 22, wherein the first router device re-sets the connection period to be shorter when an amount of data stored in a transmission buffer of at least one of the at least two piconet coordinators exceeds a predetermined amount.
